(19) United States
(12) Patent Application Publication
(10) Pub. No.: US 2021/0293371 A1
(43) Pub. Date: Sep. 23, 2021

(54) DISPLAY APPARATUS AND THE CONTROL METHOD THEREOF

(71) Applicant: Samsung Electronics Co., Ltd., Suwon-si (JP)

(72) Inventors: Eunseok CHOI, Suwon-si (KR); Joonhyun YANG, Suwon-si (KR)

(73) Assignee: Samsung Electronics Co., Ltd., Suwon-si (JP)

(21) Appl. No.: 17/137,619

(22) Filed: Dec. 30, 2020

Related U.S. Application Data
(60) Provisional application No. 62/992,296, filed on Mar. 20, 2020.

(30) Foreign Application Priority Data
Jul. 3, 2020 (KR) 10-2020-0082212

(51) Int. Cl. F16M 11/10; G09G 3/20

(52) U.S. Cl. CPC F16M 11/105; G09G 2354/00; G09G 2340/0492; G09G 3/20

(57) ABSTRACT

Disclosed are a display apparatus and a control method thereof. A display apparatus includes a display, a body unit configured to support the display, a motor configured to rotate the display with respect to the body unit, a sensor configured to detect rotation of the display, a controller configured to output a driving signal to rotate the display to the motor, based on collision of the display with an object being identified based on a driving signal output to the motor and a signal received from the sensor while the display is rotated, interrupt output of the driving signal and obtain information about a rotation angle of the display based on the signal received from the sensor and a processor configured to control the display to display a user interface (UI) associated with the collision based on the information about the rotation angle.

### CROSS-REFERENCE TO RELATED APPLICATION

This application is based on and claims priority under 35 U.S.C. § 119 to U.S. Provisional Patent Application No. 62/992,296, filed on Mar. 20, 2020, in the United States Patent and Trademark Office, and Korean Patent Application No. 10-2020-0082212, filed on Jul. 3, 2020, in the Korean Intellectual Property Office, the disclosure of which are incorporated by reference herein in their entireties.

### BACKGROUND

### 1. Field

The disclosure relates to a display apparatus and a control method thereof and, more specifically, to a display apparatus including a rotatable display and a control method thereof.

### 2. Description of Related Art

Recently, various electronic devices have been developed with the development of electronic technologies. In particular, a display apparatus including a rotatable display has been developed.

A rotatable display apparatus can rotate a display arranged in a landscape state to a portrait state or rotate a display in a portrait state to a landscape state when a user command for rotation is input.

When the display is rotated while a person or an article is located within the rotation radius of the display, the display can collide with a person or an article.

In this case, the rotation of the display needs to be interrupted. If the display is continuously rotated even after the collision, the user who collides with the display is at a danger of being injured, and the display or the article which collides with the display can be damaged.

It is necessary to inform the user that the rotation of the display is interrupted due to collision, by displaying a user interface (e.g., a pop-up message indicating that collision has occurred) associated with the collision at the time when the collision occurs.

### SUMMARY

According to an aspect of an embodiment of the disclosure, there is provided a display apparatus which, when a display collides with an object, interrupts rotation of the display and displays a user interface (UI) related to the collision and a control method thereof.

According to an embodiment, a display apparatus includes a display, a body unit configured to support the display, a motor configured to rotate the display with respect to the body unit, a sensor configured to detect rotation of the display, a controller configured to output a driving signal to rotate the display to the motor, based on collision of the display with an object being identified based on a driving signal output to the motor and a signal received from the sensor while the display is rotated, interrupt output of the driving signal and obtain information about a rotation angle of the display based on the signal received from the sensor and a processor configured to control the display to display a user interface (UI) associated with the collision based on the information about the rotation angle.

The controller is further configured to, based on collision of the display with the object being identified while the display rotates in a first direction, interrupt output of the driving signal, set a rotation angle of the display of which rotation is interrupted in accordance with the interruption of output of the driving signal to an initial angle, output a driving signal to rotate the display in a second direction to the motor, and while the display rotates in the second direction based on the driving signal, obtain information about the rotation angle of the display based on the initial angle and the driving signal, and the processor is further configured to, while the display rotates in the second direction, control the display to display a user interface (UI) associated with the collision based on the information about the rotation angle of the display.

The driving signal may be a pulse signal, the sensor may output a pulse signal whenever the display rotates by a predetermined angle, and the controller, based on a relationship between a number of pulse signals output to the motor and a number of pulse signals received from the sensor not satisfying a predetermined relationship, may identify that the display collides with the object.

The controller is further configured to, based on the display being identified as not colliding with the object while the display rotates in a first direction, complete rotation of the display based on the number of pulse signals output to the motor, and based on the display being identified as colliding with the object while the display rotates in the first direction, output a pulse signal to rotate the display in a second direction to the motor, and based on a switch of the display apparatus being turned on by a bar of a gear coupled to the display as the display rotates in the second direction, complete rotation of the display.

The controller is further configured to, while the display in a first posture rotates in a first direction based on the driving signal, obtain information about a rotation angle of the display based on the initial angle set to the display of the first posture and the driving signal, and the processor is further configured to, while the display rotates in the first direction, control the display to display an image based on the information about the rotation angle of the display.

The processor is further configured to, while the display rotates in the first direction, control the display to rotate and display the image based on the rotation angle of the display in a second direction which is opposite to the first direction.

The controller is further configured to, based on collision of the display with an object being identified, set a rotation of the display of which rotation is interrupted by interruption of output of the driving signal to an initial angle, output a driving signal to rotate the display in a second direction to the motor, and while the display rotates in the second direction based on the driving signal, obtain information on a rotation angle of the display based on the initial angle set based on the collision with the object and the motor control signal, and the processor is further configured to, while the display is rotating in the second direction, control the display to display an image based on information on the rotation angle of the display.

The processor is further configured to, while the display is rotating in the second direction, control the display to rotate and display the image in the first direction based on the rotation angle of the display.

The processor is further configured to control the display to overlap and display the UI associated with the collision on the image.

The processor is further configured to receive, from the controller, information about the rotation angle of the display at a predetermined time interval, apply interpolation to the information on the rotation angle of the display received from the controller at a first time and information on the rotation angle of the display received from the controller at a second time to identify a rotation angle of the display between the first time and the second time, and control the display to display an image based on the rotation angle of the display.

A method of controlling of a display apparatus according to an embodiment includes outputting a driving signal to rotate the display to a motor, based on collision of the display with an object being identified based on a driving signal output to the motor and a signal received from the sensor while the display is rotated, interrupting output of the driving signal and obtaining information about a rotation angle of the display based on the signal received from the sensor and displaying a user interface (UI) associated with the collision based on the information about the rotation angle.

The obtaining may include, based on collision of the display with the object being identified while the display rotates in a first direction, interrupting output of the driving signal, setting a rotation angle of the display of which rotation is interrupted in accordance with the interruption of output of the driving signal to an initial angle, outputting a driving signal to rotate the display in a second direction to the motor, and while the display rotates in the second direction based on the driving signal, and obtaining information about the rotation angle of the display based on the initial angle and the driving signal, and the displaying may include, while the display rotates in the second direction, displaying a user interface (UI) associated with the collision based on the information about the rotation angle of the display.

The driving signal is a pulse signal, and the sensor outputs a pulse signal whenever the display rotates by a predetermined angle, and the identifying may include, based on a relationship between a number of pulse signals output to the motor and a number of pulse signals received from the sensor not satisfying a predetermined relationship, identifying that the display collides with the object.

The method may further include, based on the display being identified as not colliding with the object while the display rotates in a first direction, completing rotation of the display based on the number of pulse signals output to the motor, and based on the display being identified as colliding with the object while the display rotates in the first direction, outputting a pulse signal to rotate the display in a second direction to the motor, and based on a switch of the display apparatus being turned on by a bar of a gear coupled to the display as the display rotates in the second direction, completing rotation of the display.

The obtaining may include, while the display in a first posture rotates in a first direction based on the driving signal, obtaining information about a rotation angle of the display based on the initial angle set to the display of the first posture and the driving signal, and while the display rotates in the first direction, displaying an image based on the information about the rotation angle of the display.

The displaying may include, while the display rotates in the first direction, rotating and displaying the image based on the rotation angle of the display in a second direction which is opposite to the first direction.

The obtaining may include, based on collision of the display with an object being identified, setting a rotation of the display of which rotation is interrupted by interruption of output of the driving signal to an initial angle, outputting a driving signal to rotate the display in a second direction to the motor, and while the display rotates in the second direction based on the driving signal, obtaining information on a rotation angle of the display based on the initial angle set based on the collision with the object and the motor control signal, and the displaying further comprises, while the display is rotating in the second direction, displaying an image based on information on the rotation angle of the display.

The displaying may include, while the display is rotating in the second direction, rotating and displaying the image in the first direction based on the rotation angle of the display.

The displaying may include overlapping and displaying the UI associated with the collision on the image.

The displaying may further include receiving, from the controller, information about the rotation angle of the display at a predetermined time interval, applying interpolation to the information on the rotation angle of the display received from the controller at a first time and information on the rotation angle of the display received from the controller at a second time to identify a rotation angle of the display between the first time and the second time, and displaying an image based on the rotation angle of the display.

According to various embodiments, a display apparatus may interrupt rotation when a display apparatus collides with an object. Accordingly, injury to a user who collides with a display may be prevented, and damage to a display and an object may be avoided. By displaying a user interface (UI) associated with collision based on a rotation angle of a display, a user may easily identify that rotation of a display is interrupted by collision.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a diagram illustrating a display apparatus of a landscape posture (or traverse gesture) according to an embodiment;

FIG. 1B is a diagram illustrating rotation of a display apparatus according to an embodiment;

FIG. 1C is a diagram illustrating a display apparatus of a portrait posture (or longitudinal posture) according to an embodiment;

FIG. 2 is a block diagram illustrating a display apparatus according to an embodiment;

FIG. 3 is a diagram illustrating an internal configuration of a display apparatus according to an embodiment;

FIG. 4 is a diagram illustrating an embodiment of displaying an image by a display apparatus according to an embodiment;

FIG. 5A is a diagram illustrating a user interface (UI) displayed on a display after collision according to an embodiment;

FIG. 5B is a diagram illustrating a display returning to an original state after collision according to an embodiment;

FIG. 5C is a diagram illustrating a display returning to an original state after collision according to an embodiment;

FIG. 6 is a diagram illustrating a switch according to an embodiment;

FIG. 7A is a diagram illustrating an example that a switch is implemented as one according to an embodiment;

FIG. 7B is a diagram illustrating a switch including a gear according to an embodiment;

FIG. 8 is a flowchart illustrating an operation of a display apparatus according to an embodiment;

FIG. 9 is a block diagram illustrating a display apparatus according to an embodiment; and

FIG. 10 is a flowchart illustrating an operation of a display apparatus according to an embodiment.

### DETAILED DESCRIPTION

The terms used in the present disclosure and the claims are general terms identified in consideration of the functions of the various example embodiments of the disclosure. However, these terms may vary depending on intention, legal or technical interpretation, emergence of new technologies, and the like of those skilled in the related art. Also, some arbitrary terms may be used. Unless there is a specific definition of a term, the term may be understood based on the overall contents and technological common sense of those skilled in the related art.

In describing the disclosure, when it is determined that a specific description of related known functions or configurations may obscure the gist of the disclosure, the detailed description thereof will be reduced or omitted.

The disclosure will be described in detail with reference to the accompanying drawings and the description of the accompanying drawings, but the disclosure is not limited or limited by embodiments.

The disclosure will be described in detail with reference to the attached drawings.

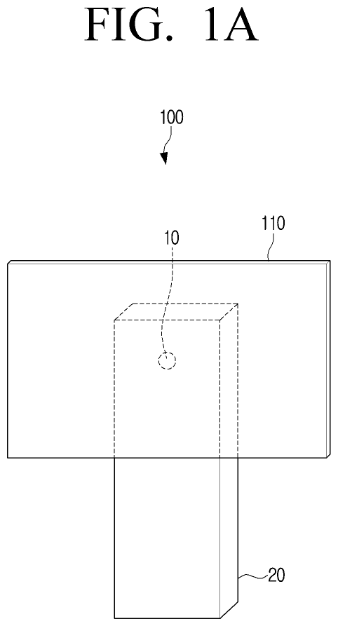

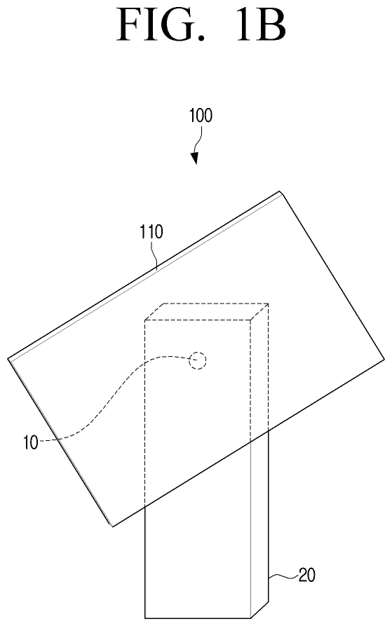

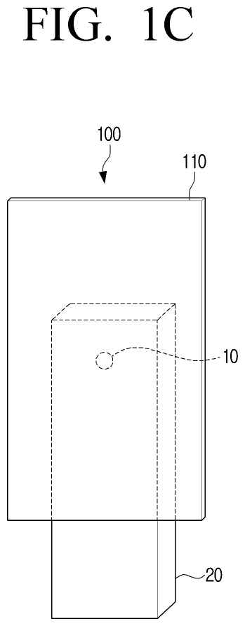

FIGS. 1A to 1C are diagrams illustrating an operation of a display apparatus according to an embodiment. A display apparatus 100 may be implemented as various display devices such as a television (TV), a smart TV, a monitor, an e-frame, e-black board, e-table, a notebook personal computer (PC), and a large format display (LFD).

When an event for rotating a display 110 is generated, the display apparatus 100 can rotate the display 110. Here, an event to rotate the display 110 may be an example in which, when a user command to rotate the display 110 is input, the resolution of the image is changed or a user terminal device communicating with the display apparatus 100 is rotated, but the embodiment is not limited thereto.

Referring to FIGS. 1A to 1C, the display apparatus 100 may include a display 110 and a body unit 20. The body unit 20 is a configuration to support the display 110, and the display 110 may be coupled to the body unit 20 and may rotate with respect to the body unit 20. As an example, as shown in FIGS. 1A to 1C, the display 110 can be rotated with respect to a rotation center 10 of the body unit 20.

According to an embodiment, the display 110 may rotate in a landscape posture (or transverse posture) or portrait posture (or longitudinal posture).

Here, the landscape posture is a posture in which the transverse length of the display is longer than the longitudinal length, and the portrait posture can be a posture in which the longitudinal length of the display 110 is longer than the transverse length of the display 110.

For example, when a user command to rotate the display 110 is input in a state where the display 110 is in a landscape posture as shown in FIG. 1A, the display apparatus 100 can rotate the display 110 in a counterclockwise direction.

In this case, the display 110 may become a portrait posture illustrated as in FIG. 1C after going through the posture as in FIG. 1B.

When a user command to rotate the display 110 is input in a state where the display 110 is in a portrait posture as shown in FIG. 1C, the display apparatus 100 can rotate the display 110 in a clockwise direction.

The display 110 may become a landscape posture as illustrated in FIG. 1A after the posture of FIG. 1B.

The embodiment in which the display 110 is rotated is not limited to the embodiment shown in FIGS. 1A-1C. For example, the display 110 may rotate in a clockwise direction in a landscape posture to be a portrait posture, or may be rotated counterclockwise in a portrait posture to be in a landscape posture.

It has been described that the display 110 is rotated 90 degrees in a clockwise or counterclockwise direction by 90 degrees to be a portrait posture or landscape posture, but the embodiment is not limited thereto. For example, the display 110 may rotate 90 degrees in a counterclockwise direction or a clockwise direction in a portrait posture to be a landscape posture, and may be a portrait posture by rotating 90 degrees more in the same direction in the landscape posture.

When the display 110 is rotated, if an object is present in the rotation radius of the display 110, the display 110 can collide with the object. Here, the object can be a person or an article.

As such, when the display 110 and the object collide, it is necessary to interrupt the rotation of the display 110. When the display 110 is rotated even after the collision, the user colliding with the display 110 is at a danger of being injured, and the display 110 or the article which collides with the display 110 can be damaged.

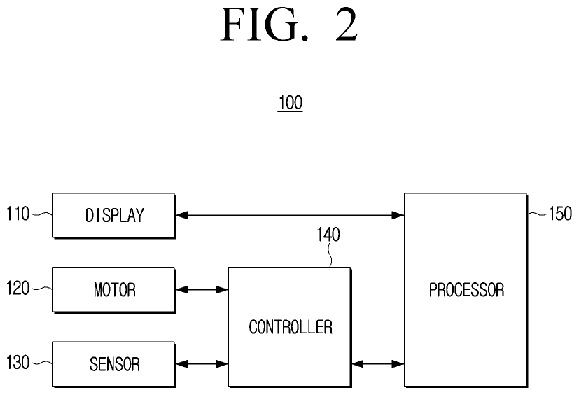

In order to remove such a danger, the display apparatus 100 according to an embodiment can interrupt rotation of the display 110 when the display 110 is identified to collide with an object. Hereinafter, the embodiment will be described with reference to FIG. 2.

FIG. 2 is a block diagram illustrating a display apparatus according to an embodiment.

Referring to FIG. 2, the display apparatus 100 according to an embodiment may include the display 110, a motor 120, a sensor 130, a controller 140, and a processor 150.

The display 110 can display various images. Here, the image includes at least one of a still image or a moving image, and the display 110 may display various images such as broadcast content, multimedia content, etc. The display 110 may display various user interfaces (UI) and icons.

The display 110 can be rotated according to the operation of the motor 120. Specifically, the display 110 can be rotated with respect to the rotation center 10 while a front surface is maintaining a predetermined direction. Here, the rotation center 10 may be a geometric center position of the display 110, but is not limited thereto, and may be other positions of the display 110.

According to one embodiment, the display 110 can be rotated between a first posture and a second posture perpendicular to the first posture. In one example, the display 110 can be rotated in a first direction from a first posture to be a second posture, and can be rotated from the second posture in a second direction to be the first posture.

The first posture can be one of a portrait posture and a landscape posture, and the second posture can be the remaining one. That is, the first posture can be a posture perpendicular to the second posture. In addition, the first direction can be one of the clockwise and counterclockwise directions and the second direction may be the remaining one.

For convenience of description, the first posture is a portrait posture, a second posture is a landscape posture, a first direction is a clockwise direction, and a second direction is assumed to be a counterclockwise direction.

The display 110 can be implemented in various types of displays, such as a liquid crystal display panel (LCD), a light emitting diode (LED), organic light emitting diodes (OLED), liquid crystal on silicon (LCoS), digital light processing (DLP), etc. In addition, a driving circuit, a backlight unit, etc. can be included in the display 110 in a form such as a-si TFT, a low temperature poly silicon (LTPS) TFT, an organic TFT (OTFT), or the like.

The display 110 may be combined with a touch sensor to be implemented as a touch screen.

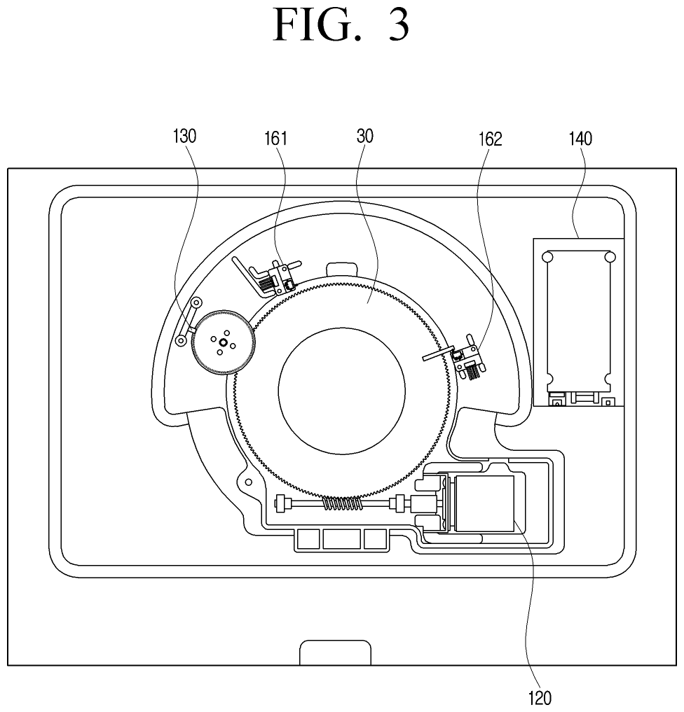

The motor 120 may rotate the display 110. This will be described with reference to FIG. 3.

FIG. 3 is a diagram illustrating an internal configuration of a display apparatus according to an embodiment. The structure of FIG. 3 is an embodiment, and the arrangement position, arrangement type, and connection structure of the motor 120, the sensor 130, and the controller 140 can be different from that of FIG. 3 according to an embodiment. In addition, although not shown in FIG. 3, the display apparatus 100 can further include the processor 150 electrically connected to the controller 140.

The motor 120 can rotate the display 110 according to the control of the controller 140. Specifically, referring to FIG. 3, the motor 120 can be arranged at a position to rotate a gear 30 (for example, a circular gear) coupled with the display 110 and ma rotate the display 110 by rotating the gear 30 according to the control of the controller 140.

The motor 120 may interrupt rotation of the display 110 by interrupting rotation of the gear 30 according to the control of the controller 140.

The motor 120 and the gear 30 may be included in the body unit 20 of the display apparatus 100 and the gear 30 may be, for example, coupled with the display 110 at the rotation center 10.

As such, the motor 120 can be a step motor as an example. In this case, the motor 120 can be rotated by a predetermined angle based on the pulse signal output by the controller 140. In one example, the motor 120 can be a step motor which rotates 1.8 degrees per one pulse.

The step motor described above is an embodiment, and the motor 120 may be implemented with various motors that can generate rotational force. For example, the motor 120 can be an alternating current (AC) motor, a direct current (DC) motor, or the like.

The sensor 130 may sense the rotation of the display 110. Specifically, the sensor 130 may sense the rotation of the gear 30 rotated by the motor 120 and may sense the rotation of the display 110 coupled to the gear 30.

In one example, the sensor 130 may be implemented as an encoder (e.g., a rotary encoder). In this case, the sensor 130 may include a light emitting element (e.g., an LED), a rotating disk including a plurality of slots, and a light receiving element (e.g., a photodiode). The sensor 130 may sense the rotation of the display 110 based on the light output by the light emitting device passing through the slot of the rotating disk and reaching the light receiving element.

The sensor 130 can output a pulse signal while the display 110 is rotated. Specifically, while the rotating disk of the sensor 130 engaged with the gear 30 rotates as the gear 30 rotates, the light output by the light emitting element of the sensor 130 can pass through the slot of the rotating disk and reach the light receiving element. The sensor 130 may convert the light reaching the light receiving element to an electrical signal and may convert the electrical signal into a pulse signal and output the signal. The sensor 130 may further include a circuit (e.g., a waveform shaping circuit) for converting an electrical signal into a pulse signal.

The number of pulse signals outputted by the sensor 130 can be different depending on the resolving power of the sensor 130. Here, the resolving power is the number of the pulse signals outputted by the sensor 130 when the rotation axis of the sensor is rotated by one rotation. For example, if the resolution of the sensor 130 is 360, the sensor 130 can output 360 pulse signals for one rotation. The resolving power can vary depending on the characteristics and specifications of the sensor 130, such as the number of slots of the rotating disk of the sensor 130, or the like.

The sensor 130 has been described as an encoder, but the sensor 130 according to the disclosure is not limited thereto. For example, the sensor 130 can be implemented with various sensors, such as an infrared sensor, capable of sensing rotation. The sensor 130 can be implemented with an optical encoder as described above, but may be implemented as a magnetic encoder including a magnet and a magnetic force sensing sensor.

It has been described that the sensor 130 may detect the rotation of the display 110 coupled with the gear 30 by sensing the rotation of the gear 30, but the sensor 130 may sense the rotation of the display 110 by sensing the rotation of the motor 120 according to an embodiment.

When an event for rotation of the display 110 occurs, the controller 140 may output a driving signal for rotation of the display 110 to the motor 120.

For example, the controller 140 may, when a user command to rotate the display 110 is input, output a driving signal to rotate the display 110 to the motor 120.

The user command may be the selection of a specific button provided on the display apparatus 100 or a remote controller, the selection of a menu item for rotation displayed on the display 110, and the selection of a menu item for rotation displayed in a user terminal such as a smartphone. Alternatively, the user command may be a user voice input to a microphone included in the display apparatus 100 or the remote controller.

If the resolution of the image does not correspond to the posture of the current display 110, the controller 140 can output a driving signal for rotation of the display 110 to the motor 120.

In one example, when a command to display an image having a resolution in which at transverse length is longer than the longitudinal length in a posture that the display 110 is in the portrait posture, the controller 140 can output a driving signal to rotate the display 110 in the landscape position to the motor 120. When a command to display an image having a resolution in which the longitudinal length is longer than the transverse length is input in the posture where the display 110 is in the landscape posture, the controller 140 may output a driving signal to rotate the display 110 to the portrait posture to the motor 120.

The driving signal may be a pulse signal. Specifically, when an event for rotation of the display 110 is generated, a pulse signal for rotating the display 110 can be sequentially outputted to the motor 120.

The motor 120 may rotate at a predetermined angle based on the pulse signal output by the controller 140.

For example, if the motor 120 is implemented as a motor that rotates by 1.8 degrees per one pulse, and when the rotation ratio of the motor 120 and the gear 30 is 160:1 (i.e., when the motor 120 is rotated by 160, the gear 30 rotates once), the controller 140 can sequentially output the pulse signal to the motor 120 until the 8000 pulses are counted. In this case, when the motor 120 rotates 40 times, the gear 30 may rotate 90 degrees, and the display 110 coupled to the gear 30 can rotate 90 degrees.

The controller 140 can determine an angle at which the display 110 is rotated while the display 110 is rotated. Specifically, the controller 140 may determine an angle at which the display 110 is rotated based on the number of pulse signals output to the motor 120.

As an example, when the motor 120 rotates at 1.8 degrees for one pulse signal and the rotation ratio of the motor 120 and the gear 30 is 160:1, the motor 120 can rotate the display 110 by 0.01125 degrees, if one pulse signal is output by the controller 140. In this case, the controller 140 can determine an angle by calculating a rotation angle of the display 110, that is 0.01125 degrees, which is a rotation angle of the display 110 rotated by the motor 120 per pulse, as an angle that the display 110 is rotated.

The controller 140 can obtain information about the rotation angle of the display 110 based on the initial angle of the display 110 and the operation of the angle rotated by the display 110.

The initial angle of the display 110 can be set based on the posture of the display 110. In one example, an initial angle when the display 110 is in a first posture (e.g., a portrait posture) may be set to 90 degrees, and an initial angle when the display 110 is a second posture (e.g., a landscape posture) can be set to zero degrees.

Specifically, if the display 110 of the landscape posture is rotated in a portrait posture, the controller 140 can obtain information about the rotation angle of the display 110 by summing the angle rotated by the display 110 at the zero degree of the initial angle. In one example, when the rotation angle of the display 110 rotated by the motor 120 per one pulse is 0.01125 degrees, the controller 140 can determine 0.1125 degrees which is a sum of the rotation angle 0.1125 degrees of the 1110 and the initial angle zero degrees as the rotation angle of the display 110.

If the display 110 of a portrait posture is rotated in a landscape posture, the controller 140 can obtain information about the rotation angle of the display 110 by subtracting the angle rotated by the display 110 at 90 degrees, which is an initial angle. As described above, when the rotation angle of the display 110 rotated by the motor 120 per one pulse is 0.01125 degrees, the controller 140 can determine the angle 89.8875 which is obtained by subtracting the rotation angle of the 110 which is 0.1125 degrees from the initial angle 90 degrees, as the rotation angle of the display 110, when ten pulse signals are output.

The controller 140 can transmit information on the rotation angle of the display 110 to the processor 150. Specifically, the controller 140 can transmit information about the rotation angle of the display 110 obtained while the display 110 is rotated to the processor 150 electrically connected to the controller 140.

The processor 150 may display an image based on information on a rotation angle of the display 110.

The processor 150 can control the display 110 to display an image based on information about the rotation angle of the display 110 and resolution information of the image.

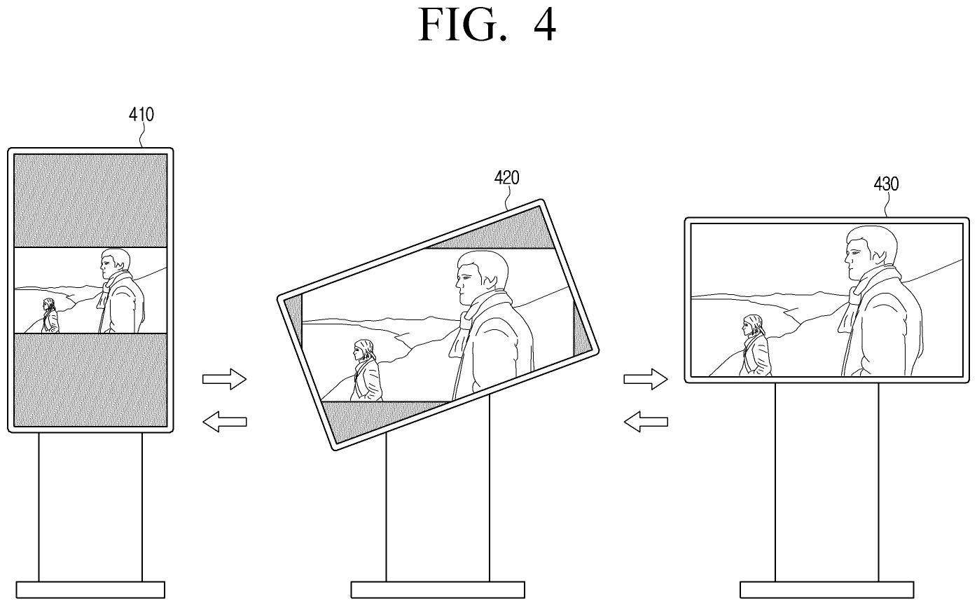

In one example, the processor 150 can control the display 110 to display an image having a resolution of 1920×1080 through a screen 410 of the display 110 rotated at 90 degrees, as shown in FIG. 4, when the resolution of the image is 1920×1080 and the rotation angle of the display 110 is 90 degrees which is identified based on information about the rotation angle of the display 110.

If the rotation angle of the display 110 identified based on the information on the rotation angle of the display 110 is zero degrees, the processor 150 can control the display 110 to display an image having a resolution of 1920×1080 through a screen 430 of the zero-degree rotated display 110, as shown in FIG. 4.

The processor 150 can control the display 110 to receive information about the rotation angle of the display 110 from the controller 140 while the display 110 is rotated, and rotate and display an image based on information on a rotation angle of the display 110 which is changed according to rotation.

The processor 150 may, when the display 110 is rotated in a first direction from a first posture (e.g., a portrait posture), the display 110 can be controlled to rotate the image in a second direction based on information about the rotation angle of the display 110, and when the display 110 is rotated in a second direction (e.g., landscape posture), the display 110 can be controlled to rotate the image in a first direction based on information about the rotation angle of the display 110.

As an example, as shown in FIG. 4, when the display 110 is rotated by an angle A in the first direction (see 420 in FIG. 4), while an image is being displayed through the screen 410 of the display 110 rotated at 90 degrees as illustrated in FIG. 4, the processor 150 may rotate the image by angle A in the second direction and display the rotated image through the screen 420 of the rotated display 110.

Alternatively, as shown in FIG. 4, while an image is being displayed through the screen 430 of the display 110 which is rotated by zero degrees, when the display 110 is rotated by an angle B in the second direction (see 420 in FIG. 4), the processor 150 may rotate the image by angle B in the first direction and display the rotated image through the screen 420 of the rotated display 110.

Accordingly, while the display 110 is being rotated, the user may receive an image, for example, which is parallel with a ground, instead of an inclined image.

The controller 140 may receive a signal output by the sensor 130 from the sensor 130, while the display 110 is rotated.

The signal output by the sensor 130 can be a pulse signal as described above. Specifically, the sensor 130 can output a pulse signal whenever the display 110 is rotated by a predetermined angle.

For example, if the display 110 is the sensor 130 for outputting a pulse signal when the display 110 rotates in a range of 0.1125 degrees, the sensor 130 can output 800 pulse signals when the display 110 is rotated by one quarter (i.e., by 90 degrees).

The controller 140 may identify whether the display 110 collides with an object based on a signal received from the sensor 130 and a driving signal output to the motor 120.

Specifically, if the relation between the number of pulse signals outputted to the motor 120 and the number of pulse signals outputted from the sensor 130 does not satisfy a predetermined relationship, the controller 140 can identify that the display 110 collides with an object.

The predetermined relationship can be determined based on a ratio between the number of pulse signals required to rotate the display 110 of the first posture to the second posture and the number of pulse signals to be outputted from the sensor 120 when the display 110 is rotated in the second position in the first posture.

For example, if the number of pulse signals needed to rotate the display 110 of the first posture is to the second posture is 8000, and the number of pulse signals to be outputted from the sensor 120 when the display 110 is rotated from the first posture to the second posture (i.e., the display 110 is rotated by 90 degrees) is 800, the predetermined relationship can be 10:1.

In one example, if the number of pulse signals outputted to the motor 120 is 4000, but the number of pulse signals output from the sensor 120 is 390, instead of 400, the predetermined relationship is not satisfied, and the controller 140 can identify that the display 110 collides with an object.

In this case, the controller 140 may interrupt the output of the driving signal and obtain information about the rotation angle of the display 110 based on the signal received from the sensor 130. Specifically, the controller 140 can obtain information about the rotation angle of the display 110 based on the number of pulse signals received from the sensor 130.

In an example, when the sensor 130 outputs a pulse signal when the display 110 rotates about 0.1125 degrees, if the 390 pulse signals are outputted from the sensor 130, the controller 110 can identify the rotation angle of the display 110 as 43.875. That is, when the rotation angle of the display 110 is 43.875 degrees, the controller 140 can determine that the display 110 collides with the object.

It has been described that the controller 140 identifies the rotation angle of the display 110 based on the number of pulse signals received from the sensor 130, but the rotation angle of the display 110 may be determined by the sensor 130 according to an embodiment. In this case, if the rotation angle of the display 110 determined based on the rotation angle of the display 110 determined based on the number of the pulse signal output by the motor and the information on the rotation angle of the display 110 received from the sensor 130 is different than the error range, the controller 140 can determine that the display 110 collides with the object. The controller 140 may interrupt the output of the driving signal and identify the rotation angle of the display 100 of which rotation is interrupted as the display 110 collides with the object, based on the information about the rotation angle of the display 110 received from the sensor 130.

The controller 140 may transmit information about collision with the object and information about the rotation angle of the display 110 of which rotation is interrupted by collision to the processor 140.

In this case, the processor 140 can display a user interface (UI) associated with the collision through the display 110 of which the rotation is interrupted. Specifically, the processor 140 may identify that the display 110 collides with an object when collision information is received from the controller 140, and may control the display 110 so as to display the UI associated with the collision based on the information about the rotation angle of the display 110, which is received from the controller, and of which rotation is interrupted.

Similarly, when the display 110 of the second posture (e.g., landscape posture) is rotated by a predetermined angle in the first direction, the rotation can be interrupted due to collision with an object 200. In this case, the processor 150 can control the display 110 to display the UI associated with the collision similar to the technical idea described above.

In one example, if it is identified that the display 110 collides with an object while rotating in the second direction by 60 degrees, the processor 150 can control the display 110 to display a UI associated with collision of rotation by 60 degrees in the first direction through a screen of the display 110 rotated by 60 degrees in the second direction, based on the information received from the controller 140.

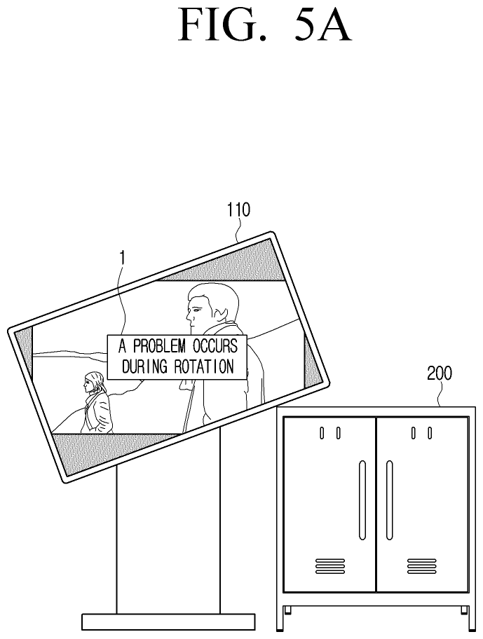

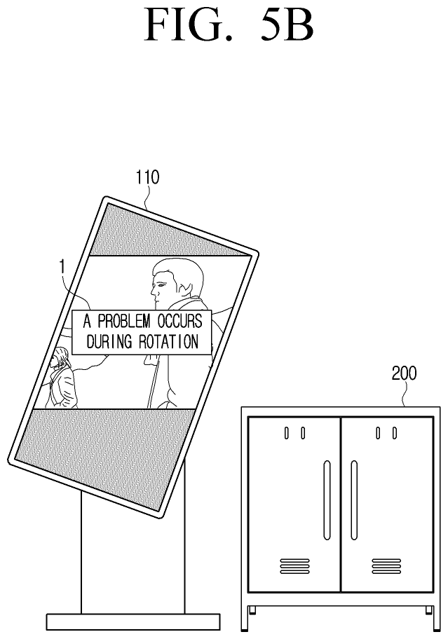

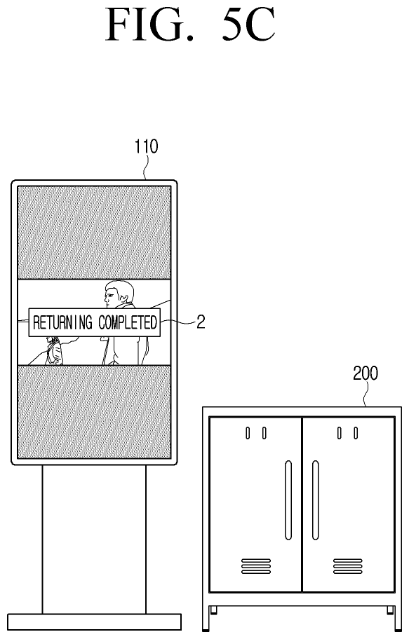

The UI associated with collision is an example, and, as shown in FIG. 5A, may be a message indicating that a problem occurs in rotation of the display 110 such as “a problem occurs during rotation” (1), but the embodiment is not limited thereto.

In one example, the UI associated with the collision may be a UI to receive a user command to continue to rotate the display 110 or rotate the display 110 in the reverse direction. For example, the UI associated with the collision may be a UI including a message such as “A collision is detected. Do you want to return to the original state?” or a UI including a first menu item for returning to the original state and a second menu item for continuing rotation.

When a user command for selecting a first menu item for returning to the original state is received, the processor 150 may control the controller 140 to rotate the display 110 in the reverse direction and return to the original state, and when a user command to select a second menu item for continuing rotation is received, the processor 150 can control the controller 140 to continuously rotate the display 110.

When the controller 140 identifies that the display 110 collides with an object, the controller 140 can set the rotation angle of the display 110 of which rotation is interrupted due to rotation to an initial angle.

In an example, when the display 110 collides with an object in a state where the rotation angle of the display 110 is 60 degrees, the controller 140 can set 60 degrees which is the rotation angle of the display 110 of which rotation is interrupted due to collision to the initial angle of the display 110.

The controller 140 can output a driving signal to rotate the display 110 in a reverse direction to the motor 120 when a user command for selecting a menu item for the original return is received, if it is identified that the display 110 collides with an object.

In this case, the controller 140 can obtain information about the rotation angle of the display 110 based on the initial angle set due to the collision and the driving signal output to the motor 120.

If the display 110 returns to a portrait posture, the controller 140 can obtain information about the rotation angle of the display 110 by summing the angle rotated by the display 110 with an initial angle set due to the collision. As described above, when the rotation angle of the display 110 rotated by the motor 120 per one pulse is 0.01125, and the initial angle set due to the collision is 60 degrees, the controller 140 can identify 61.125 degrees which is obtained by summing the initial angle 60 degrees and 1.125 degrees which is an angle at which the display 110 is rotated as the rotation angle of the display 110.

If the display 110 is returned to the landscape posture, the controller 140 can obtain information about the rotation angle of the display 110 by subtracting the angle rotated by the display 110 from the initial angle set due to the collision. As described above, when the rotation angle of the display 110 rotated by the motor 120 per one pulse is 0.01125 degrees, and the initial angle set due to the collision is 60 degrees, the controller 140 can identify the angle of 58.875 degrees which is obtained by subtracting 1.125 degrees that is the angle rotated by the display 110 from the initial angle 60 set by the collision, as the rotation angle of the display 110, if 100 pulse signals are output.

The controller 140 can transmit information on the rotation angle of the display 110 to the processor 150. Specifically, the controller 140 can transmit, to the processor 150, information about the rotation angle of the display 110 obtained while the display 110 is returned to the original state.

Accordingly, the processor 150 can display a UI associated with the image and/or the collision based on information about the rotation angle of the display 110 while the display 110 is returned to the original state.

As an example, as described above, when the display 110 is rotated at 1.125 degrees to return to the portrait posture after colliding with the object 200, the processor 150 can determine the rotation angle of the display to 61.125 degrees based on information about the rotation angle of the display 110 received from the controller 140. In this case, the processor 150 can control the display 110 so that the UI associated with the image and/or the collision is rotated in the first direction by 61.125 degrees and displayed, as shown in FIG. 5B.

When the display 110 collides with the object 200 and then rotates at 1.125 degrees to return to the landscape posture, the processor 150 can determine the rotation angle of the display 110 to 58.875 degrees based on information about the rotation angle of the display 110 received from the controller 140. In this case, the processor 150 can control the display 110 so that the UI associated with the image and/or the collision is rotated in the second direction by 58.875 degrees and displayed.

Accordingly, the user can be provided with UI related to an image and/or a collision that is horizontal to the ground, rather than a UI associated with an inclined image and/or a collision, even while the display 110 is returned.

After the display 110 returns to an original posture, the processor 150 can display a UI including a message 2, such as a “returning completed”, as shown in FIG. 5C when the display 110 is returned to the original position.

The user can recognize that the display 110 is returned to the original state by the collision between the display 110 and the object, and can move the display apparatus 100 or nearby object to another location.

The controller 140, as described above, can output the pulse signal to the motor 120 sequentially until the 8000 pulses are counted when the motor 120 is implemented as a motor that rotates 1.8 degrees per one pulse and the rotation ratio of the motor 120 and the gear 30 is 160:1, as described above. The controller 140 may identify that the rotation of the display 110 is completed when the 8000 pulses are counted, and may interrupt the output of the pulse signal.

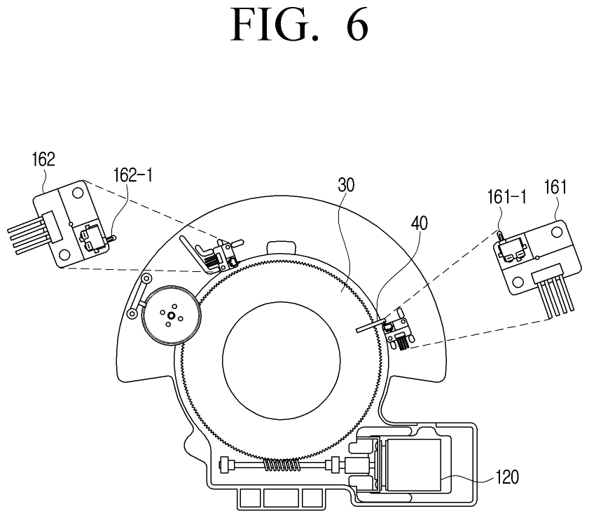

The controller 140 may sequentially output the pulse signal to the motor 120 until the at least one switch 161, 162 included in the display apparatus 100 is turned on, of the display 110 collides with an object. Hereinafter, the embodiment will be described with reference to FIG. 6.

FIG. 6 is a diagram illustrating a switch according to an embodiment.

According to one embodiment, the display apparatus 100 can include a first switch 161 which is pressed while the display 100 is in a first posture (e.g., a portrait posture) and a second switch 162 which is pressed in a state where the display 110 is in a second posture (e.g., a landscape posture).

Specifically, referring to FIG. 6, a bar 161-1 of the first switch 161 may be pressed by a bar 40 included in the circular gear 30 while the display 110 is in the first posture. Similarly, a bar 162-1 of the second switch 162 can be pressed by the bar 40 included in the circular gear 30 while the display 110 is in a second posture. That is, the first switch 161 may be turned on while the display 110 is in the first posture, and the second switch 162 may be turned on while the display 110 is in the second posture.

The controller 140 can output a driving signal to rotate the display 110 in the first direction to the motor 120, when an event for rotating the display 110 of the first posture to the second posture occurs. At this time, the first switch 161 can be turned off as the display 110 rotates in the first direction.

The controller 140 can identify the display 110 and the object collide based on the number of pulse signals output to the motor 120 and the number of pulse signals received from the sensor 130 while the display 110 is rotated.

When it is identified that the display 110 does not collide with an object, the controller 140 can output a pulse signal to the motor 120 until a predetermined number of pulse signals are counted. When the predetermined number of pulse signals is counted, the controller 140 may identify that the display 110 is rotated in the second posture and may interrupt the output of the pulse signal.

If it is identified that the display 110 that is rotated in the first direction is collided with the object, the controller 140 may interrupt the output of the pulse signal and output a pulse signal to rotate the display 110 in the second direction to the motor 120.

In this case, when the switch (i.e., the first switch) is turned on as the display 110 is rotated in the second direction (i.e., the first switch is pressed), the controller 140 may identify that the display 110 is rotated in the second posture and may interrupt the output of the pulse signal.

Similarly, the controller 140 can output a pulse signal to rotate the display 110 in the second direction to the motor 120, when an event for rotating the display 110 to the first posture occurs in the state where the display 110 is in the second posture (i.e., the state in which the second switch is pressed).

When it is identified that the display 110 does not collide with the object, the controller 140 can output a pulse signal to the motor 120 until a predetermined number of pulse signals are counted. When the predetermined number of pulse signals is counted, the controller 140 may identify that the display 110 is rotated in the first posture and may interrupt the output of the pulse signal.

If it is identified that the display 110 which is rotated in the second direction collides with the object, the controller 140 may interrupt the output of the pulse signal and output a pulse signal to rotate the display 110 in the first direction to the motor 120.

In this case, when the switch in the off state (i.e., second switch) is turned on (i.e., the second switch is pressed) as the display 110 is rotated in the first direction, the controller 140 may identify that the display 110 is rotated in the first posture and interrupt the output of the pulse signal.

As such, when the display 100 does not collide with the object, a pulse signal may be output to the motor until the predetermined number of pulse signal is counted and when the display 100 collides with the object, the pulse signal can be output to the motor until the switch is turned on.

The rotation angle of the display 110 detected by the sensor 130 at the time of collision may consider that accuracy may fall according to the resolving power of the sensor 130, and display apparatus 100 of the disclosure can completely return the display 110 to one of the first and second postures even when the display 110 collides with the object.

The structure of the display apparatus 100 as illustrated in FIG. 6 is an embodiment, and the switch of the disclosure can be implemented as one.

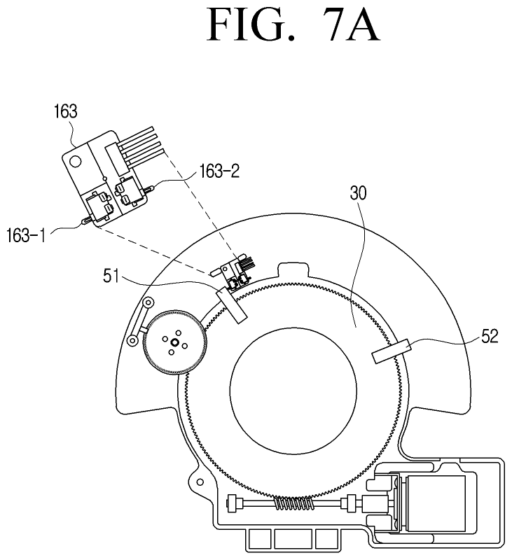

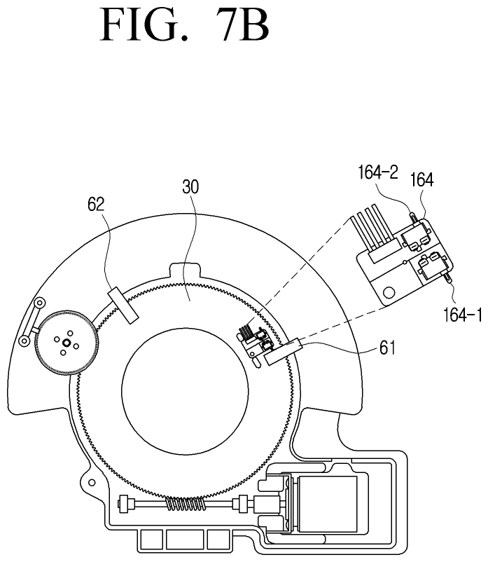

As an example, referring to FIG. 7A, a switch 163 according to one embodiment may include a first bar 163-1 which is pressed while the display 110 is in a first posture (i.e., a portrait posture) and a second bar 163-2 which is pressed in a state where the display 110 is in a second posture (i.e., a landscape posture).

In this case, the first bar 163-1 of the switch 163 can be pressed by the first bar 51 included in the circular gear 30 while the display 110 is in the first posture, and the second bar 163-2 of the switch 163 can be pressed by the second bar 52 included in the circular gear 30 while the display 110 is a second posture.

When the display 110 is returned to the original state due to collision with the object, if the first bar 163-1 or the second bar 163-2 of the switch 163 is turned on (i.e., when the switch is pressed), the controller 140 may identify that the return of the display 110 is completed and output of the pulse signal may be interrupted.

Referring to FIG. 7B, a switch 164 according to one embodiment may include a first bar 164-1 which is pressed while the display 110 is in a first posture (e.g., a portrait posture) and a second bar 164-2 which is pressed in a state where the display 110 is in a second posture (e.g., a landscape posture). Here, the switch 164 can be fixed to one region of the circular gear 30. The first and second bars 61, 62 of FIG. 7B can be fixed to the outside of the circular gear 30.

In this case, the first bar 164-1 of the switch 164 can be pressed by the first bar 61 while the display 110 is in the first posture, and the second bar 164-2 of the switch 164 can be pressed by the second bar 62 while the display 110 is in the second posture.

When the display 110 is returned due to collision with the object, the controller 140 may identify that the return of the display 110 is completed, if the first bar 164-1 or the second bar 164-2 of the switch 164 is turned on (i.e., when the switch is pressed), and may interrupt the output of the pulse signal.

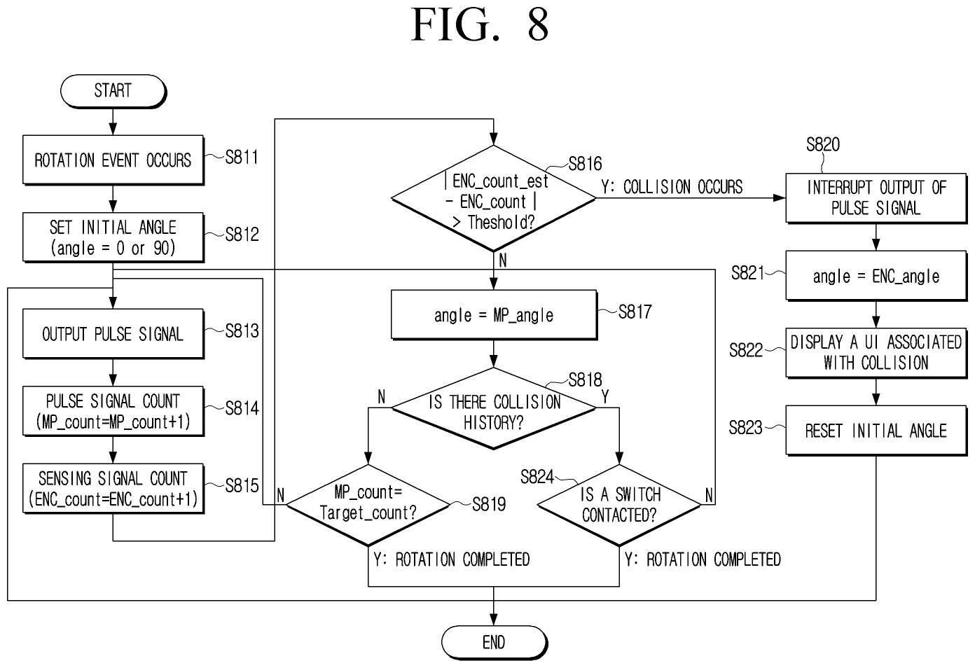

FIG. 8 is a flowchart illustrating an operation of a display apparatus according to an embodiment.

The display apparatus 100 may rotate the display 110 as a rotation event occurs in operation S811. Here, the rotation event can be the case when a signal for rotating the display 110 is received from a remote control device such as a remote controller or a smart phone.

When a rotation event occurs, the display apparatus 100 may set an initial angle based on the posture of the display 110 in operation S812. Specifically, the display apparatus 100 may set an initial angle to 90 degrees if the posture of the display 110 is the portrait posture, and if the posture of the display 110 is a landscape posture, may set the initial angle to zero degrees.

The display apparatus 100 may output a pulse signal in operation S813. Specifically, the controller 140 of the display apparatus 100 may output a pulse signal to the driver integrated circuit (IC), and the driver IC may convert the pulse signal into an analog signal and output the converted signal to the motor 120. Here, the motor 120 may perform rotation based on the pulse signal outputted by the controller 140. The motor 120 can be implemented as a step motor which rotates a predetermined angle per one pulse.

The display apparatus 100 may count the output pulse signal in operation S814. The display apparatus 100 may count the sensing signal outputted by the sensor 130 in operation S815. Here, the sensor 130 can be, for example, an encoder and output a pulse signal whenever the display 110 is rotated by a predetermined angle. That is, the sensing signal described above can be a pulse signal.

The display apparatus 100 may predict the number of sensing signals output by the sensor 130 based on the number of the output pulse signals. Specifically, the display apparatus 100 can predict the number of sensing signals outputted by the sensor 130 while outputting a pulse signal based on a ratio between the number of pulse signals required to rotate the display 110 of the first posture to the second position and the number of pulse signals that are to be outputted from the sensor 120 while the display 110 is rotated in the first posture to the second posture.

In one example, if the above-mentioned ratio is 10:1, the display apparatus 100 can predict the number of sensing signals outputted by the sensor 130 to ten when the output pulse signal is counted to 100.

The display apparatus 100 may identify whether the difference between the number of the predicted sensing signals and the number of actual sensing signals received from the sensor 130 exceeds a threshold value in operation S816.

If the difference between the number of the predicted sensing signals and the number of the actual sensing signals received from the sensor 130 does not exceed the threshold value, the display apparatus 100 may identify that the display 110 does not collide with the object and identify the rotation angle of the display 110 based on the number of the output pulse signals in operation S817.

The display apparatus 100 may identify whether the display 110 collides with an object once or more while rotating in operation S818.

If the display 110 does not collide with the object, the display apparatus 100 may continue to output a pulse signal until the number of the output pulse signals becomes the predetermined number in operation S819.

If the difference between the number of the predicted sensing signals and the number of the actual sensing signals received from the sensor 130 exceeds the threshold value, the display apparatus 100 may identify that the display 100 collides with the object and may interrupt the output of the pulse signal in operation S820.

The display apparatus 100 identify an angle at which the display 110 rotates based on the number of sensing signals received from the sensor 130 in operation S821.

The display apparatus 100 may display a UI related to a collision on the display 110 of which rotation is interrupted by collision in operation S822. Specifically, the display apparatus 100 can display a UI associated with a collision rotated by an angle in which the display 100 is rotated in a direction opposite to the direction in which the display 100 is rotated.

The display apparatus 100 may then reset the rotation angle of the display 110 at the time of collision to the initial angle in operation S823 and may output the pulse signal to return the display 110.

The display apparatus 100 may, while the display 110 rotates, perform the steps S813 to S817 as described above, and may identify whether the display 110 collides with the object once or more while the display 110 is rotated.

Since there is collision history, the display apparatus 100 may identify whether the bar of the circular gear is in contact with the switch while the display 110 is rotated in operation S824. While the display 110 rotates and the switch is in contact with the bar of the circular gear, the display apparatus 100 may identify that the return is completed and may interrupt the output of the pulse signal.

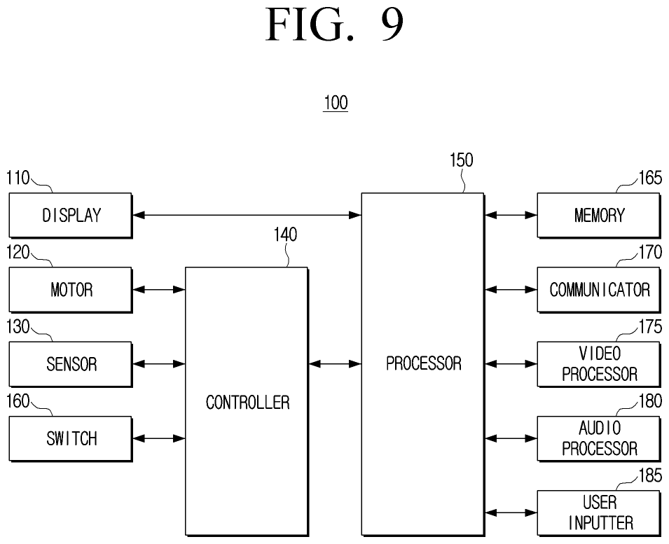

FIG. 9 is a block diagram illustrating a display apparatus according to an embodiment. A unit overlapping with the above description will be omitted or shortened.

Referring to FIG. 9, the display apparatus 100 according to an embodiment includes the display 110, the motor 120, the sensor 130, the controller 140, the switch 160, a memory 165, a communicator 170, a video processor 175, an audio processor 180, a user inputter 185, and the processor 150.

The memory 165 may store commands or data related to components of the display apparatus 100 and an operating system (OS) to control overall operations of the components of the display apparatus 100.

Accordingly, the processor 150 can control a plurality of hardware or software components of the display apparatus 100 using various commands or data stored in the memory 165, and load the commands or data received from at least one of the other components into the volatile memory and store the various data in a non-volatile memory.

The memory 165 can store information about the relationship between the number of pulse signals output to the motor 120 and the number of pulses received from the sensor 130. Here, the relationship may refer that when the number of the pulse signals to be outputted to the motor 120 is 8000 to rotate the display 110 in the first posture to the second posture and the display 110 is rotated from the first posture to the second posture (i.e., the display 110 is rotated 90 degrees), if the number of the pulse signals to be outputted from the sensor 120 is 800, the relation can be 10:1.

The communicator 170 may communicate with various electronic devices according to various types of communication methods.

The communicator 170 can include at least one communication module among a local area wireless communication module (not shown) and a wireless LAN communication module (not shown). A local area wireless communication module (not shown) is a communication module for wirelessly communicating data with an electronic device located nearby and may include a Bluetooth module, a ZigBee module, and a near field communication (NFC) module, or the like. The wireless LAN communication module (not shown) is a module that is connected to an external network according to a wireless communication protocol such as WiFi, Institute of Electrical and Electronics Engineers (IEEE), or the like.

The communicator 170 may further include a mobile communication module for performing communication by connecting to a mobile communication network according to various mobile communication standards, such as third generation (3G), 3rd Generation Partnership Project (3GPP), long term evolution (LTE), and fifth generation (5G). Further, the communicator 170 may include at least one of a wired communication module (not shown) such as universal serial bus (USB), an Institute of Electrical and elementary Engineers (IEEE) 1394, and a recommended standard 232 (R-232), and may include a broadcast receiving module for receiving a TV broadcast.

The communicator 170 can receive a user command for rotation of the display apparatus 100 from an electronic device such as a smartphone. For example, when a user command for rotation of the display apparatus 100 is inputted through the screen of the smartphone, the communicator 170 may receive a user command for rotation of the display apparatus 100 from the smartphone.

The display apparatus 100 can receive various broadcast services, Internet services, etc. from an external device through the communicator 170, and communicate with a smartphone or a laptop, and can be connected to a media device such as a sound bar.

The video processor 175 may perform signal processing on the image signal including an image frame received through the communicator 170. Specifically, the video processor 175 may perform operations such as decoding, scaling, and frame rate conversion, resolution conversion on an image signal. The image frame processed by the video processor 175 may be displayed on the display 110.

The audio processor 180 can process an audio signal received through the communicator 170. The audio processor 180 may perform decoding, amplification, and noise filtering of the audio signal. The audio signal processed by the audio processor 180 can be output through an audio outputter (not shown).

The audio outputter (not shown) can output various audio signals processed by the audio processor 180, various alarm sound or voice messages. In one example, an audio outputter (not shown) can be implemented as a speaker or the like. As an example, an audio outputter (not shown) can output a warning sound to inform a collision when the display 110 is contacted to an object.

The user inputter 180 may receive various user commands to control the operation of the display apparatus 100. In one example, the user inputter 185 may input a user command for rotation of the display 110.

The user inputter 185 can be implemented with various input devices capable of controlling the display apparatus 100, such as various buttons or touch sensors. Also, the user command may be received through an external remote controller. The user inputter 185 may include a remote control signal receiver.

The processor 150 may control overall operations of the display apparatus 100. For this purpose, the processor 150 may include one or more of a central processor (CPU), an application processor (AP), a communication processor (CP), etc.

The processor 150 may drive an operating system or application program to control hardware or software components connected to the processor 150, and may perform various data processing and operations. The processor 150 may also load and process commands or data received from at least one of the other components into volatile memory and store the various data in non-volatile memory.

The processor 150 can receive information about the rotation angle of the display 100 from the controller 140 at predetermined time intervals. Specifically, the controller 140 may generate information on the rotation angle of the display 100 based on the initial angle of the display 110 and the pulse signal output to the motor 120, and transmit information about the rotation angle of the display 100 to the processor 150 at a predetermined time interval. Here, the predetermined time interval may be a time interval in which information about the rotation angle of the display 110 is generated, but is not limited thereto.

In one example, the processor 150 may receive information about the rotation angle of the display 110 from the controller 140 at a first time and receive information about the rotation angle of the display 110 from the controller 140 at a second time.

In this case, the processor 140 can identify the rotation angle of the display 110 between the first time and the second time by applying an interpolation to information about the rotation angle of the display 110 received from the controller 140 at the first time and the information on the rotation angle of the display 110 from the controller 140 at the second time. Here, the interpolation method is a technique for estimating the rotation angle of the display 110 between the first time and the second time. In one example, the interpolation method may be a linear interpolation method but is not limited thereto, and can be a variety of techniques such as a double linear interpolation method, a triple linear interpolation method, or the like.

The processor 150 can control the display 110 to display the UI associated with the image and/or the collision based on the rotation angle of the display 110 identified based on the interpolation method.

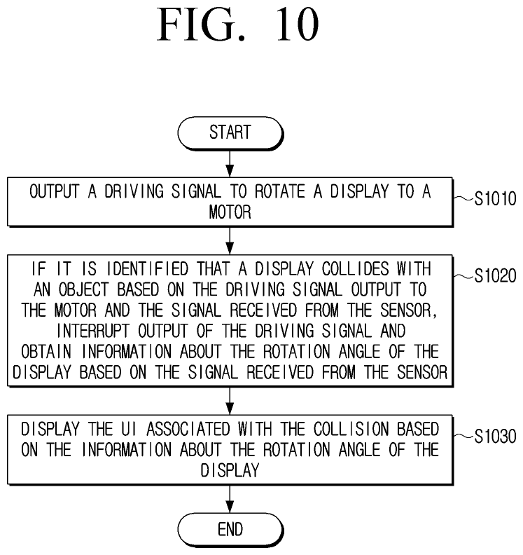

FIG. 10 is a flowchart illustrating an operation of a display apparatus according to an embodiment.

The display apparatus 100 may output a driving signal for rotating the display 110 to the motor 120 in operation S1010. Specifically, when an event for rotation of the display 110 is generated, the display apparatus 100 may output a driving signal to the motor 120 to rotate the display 110. Here, the driving signal is a pulse signal, and the display apparatus 100 can output the pulse signal to the motor 120 until a predetermined number of pulse signals are counted or until the switch of the display apparatus 100 is turned on.

The display apparatus 100 can obtain information about the rotation angle of the display 110 while the display 110 is rotated by a driving signal output to the motor 120. Specifically, the display apparatus 100 may determine an initial angle of the display 110 based on the posture of the display 110, and obtain information about the rotation angle of the display 110 while the display 110 is rotated based on the number of pulse signals output to the motor 120 and the operation of the initial angle of the display 110.

The display apparatus 100 can control the display 110 to display an image based on information about the rotation angle of the display 110. Specifically, when the display 110 is rotated by an angle a in the first direction, the display apparatus 100 may control the display 110 so that the image is rotated by angle a in the second direction, and when the display 110 is rotated by angle b in the second direction, the display apparatus 100 can control the display 110 so that the image is rotated by angle b in the first direction. Here, the image may be a broadcast image, a content image, or the like, but is not limited thereto.

While the display 110 is rotated by the driving signal output from the motor 120, if the display apparatus 100 identifies that a display 130 collides with an object based on the driving signal output to the motor 120 and the signal received from the sensor 130, the display apparatus 100 may interrupt output of the driving signal and may obtain information about the rotation angle of the display 110 based on the signal received from the sensor 130 in operation S1020. The sensor 130 can be an encoder that outputs a pulse signal whenever the display 110 is rotated by a certain angle. Specifically, when the relation between the number of the pulse signals output to the motor 120 and the number of the pulse signals received from the sensor 130 does not satisfy a predetermined relationship, the display apparatus 100 can determine that the display 110 collides with the object.

The display apparatus 100 can control the display 110 to display the UI associated with the collision based on the information about the rotation angle of the display 110 in operation S1030. Specifically, the display apparatus 100 can display a UI associated with the collision based on the rotation angle of the display 110 of the time of determining the collision. In one example, if the display 110 collides with an object while the display 110 rotates by angle 1 in the first direction, the display apparatus 100 may control the display 110 to rotate and display a UI related to the collision by angle a in the second direction and if the display 110 collides with the object while rotating by angle b in the second direction, may control the display 110 to rotate and display the UI related to collision by angle b in the first direction.

The display apparatus 100 may set the rotation angle of the display 110 at the time of determining of collision to an initial angle, and output a driving signal to return the posture of the display 110 to the original position to the motor 120. In this case, the display apparatus 100 may identify the rotation angle of the display 110 based on the preset initial angle and the number of pulse signals output to the motor 120 while returning the posture of the display 110, and control the display 110 to display the UI associated with the image and/or the collision based on the rotation angle of the display 110.

The methods according to various embodiments may be implemented as a format of software or application installable to a related art display apparatus.

The methods according to various embodiments may be implemented by software upgrade of a related art electronic apparatus, or hardware upgrade only.

The various embodiments described above may be implemented through an embedded server provided in the display apparatus or a server outside the display apparatus.

A non-transitory computer readable medium which stores a program for sequentially executing a method for controlling a display apparatus according to an embodiment may be provided.

The non-transitory computer readable medium refers to a medium that stores data semi-permanently rather than storing data for a very short time, such as a register, a cache, a memory or etc., and is readable by an apparatus. To be specific, the aforementioned various applications or programs may be stored in the non-transitory computer readable medium, for example, a compact disc (CD), a digital versatile disc (DVD), a hard disk, a Blu-ray disc, a universal serial bus (USB), a memory card, a read only memory (ROM), and the like, and may be provided.

While the disclosure has been shown and described with reference to various embodiments thereof, it will be understood by those of ordinary skill in the art that various changes in form and details may be made therein without departing from the spirit and scope of the disclosure as defined by the appended claims and their equivalents.

What is claimed is:

1. A display apparatus comprising:
a display;
a body unit configured to support the display;
a motor configured to rotate the display with respect to the body unit;
a sensor configured to detect rotation of the display;
a controller configured to:
output a driving signal to the motor to rotate the display, and,
based on collision of the display with an object being identified based on the driving signal output to the motor and a signal received from the sensor, interrupt output of the driving signal and obtain information about a rotation angle of the display based on the signal received from the sensor; and
a processor configured to control the display to display a user interface (UI) associated with the collision based on the information about the rotation angle.

2. The display apparatus of claim 1, wherein the controller is further configured to:
based on collision of the display with the object being identified while outputting a driving signal to the motor to rotate the display in a first direction, interrupt output of the driving signal to the motor to rotate the display in the first direction, set a rotation angle of the display of which rotation is interrupted in accordance with the interruption of output of the driving signal to an initial angle, output a driving signal to the motor to rotate the display in a second direction, and while the display rotates in the second direction based on the driving signal output to the motor to rotate the display in the second direction, obtain information about the rotation angle of the display based on the initial angle and the driving signal output to the motor to rotate the display in the second direction,
wherein the processor is further configured to, while the display rotates in the second direction, control the display to display a user interface (UI) associated with the collision based on the information about the rotation angle of the display based on the initial angle and the driving signal output to the motor to rotate the display in the second direction.

3. The display apparatus of claim 1, wherein:
the driving signal is a pulse signal,
the sensor outputs a pulse signal whenever the display rotates by a predetermined angle, and
the controller, based on a relationship between a number of pulse signals output to the motor and a number of pulse signals received from the sensor not satisfying a predetermined relationship, identifies that the display collides with the object.

4. The display apparatus of claim 1, wherein the controller is further configured to:
based on the display being identified as not colliding with the object while outputting a driving signal to the motor to rotate the display in a first direction, complete rotation of the display based on the number of pulse signals output to the motor, and
based on the display being identified as colliding with the object while outputting the driving signal to the motor to rotate the display in the first direction, output a pulse signal to rotate the display in a second direction to the motor, and based on a switch of the display apparatus being turned on by a bar of a gear coupled to the display as the display rotates in the second direction, complete rotation of the display.

5. The display apparatus of claim 1, wherein the controller is further configured to, while the display in a first posture rotates in a first direction based on the driving signal output to the motor, obtain information about a rotation angle of the display based on the initial angle set to the display of the first posture and the driving signal output to the motor, and
wherein the processor is further configured to, while the display rotates in the first direction, control the display to display an image based on the information about the rotation angle of the display.

6. The display apparatus of claim 5, wherein the processor is further configured to, while the display rotates in the first direction, control the display to rotate and display the image based on the rotation angle of the display in a second direction which is opposite to the first direction.

7. The display apparatus of claim 1, wherein the driving signal output to the motor is to rotate the display in a first direction, and the controller is further configured to:
based on collision of the display with an object being identified, set a rotation of the display of which rotation is interrupted by interruption of output of the driving signal to an initial angle, output a driving signal to the motor to rotate the display in a second direction, and while the display rotates in the second direction based on the driving signal output to the motor to rotate the display in the second direction, obtain information on a rotation angle of the display based on the initial angle set based on the collision with the object and the motor control signal, and
wherein the processor is further configured to, while the display is rotating in the second direction, control the display to display an image based on information on the rotation angle of the display.

8. The display apparatus of claim 7, wherein the processor is further configured to, while the display is rotating in the second direction, control the display to rotate and display the image in the first direction based on the rotation angle of the display.

9. The display apparatus of claim 8, wherein the processor is further configured to control the display to overlap and display the UI associated with the collision on the image.

10. The display apparatus of claim 1, wherein the processor is further configured to:
receive, from the controller, information about the rotation angle of the display at a predetermined time interval, apply interpolation to the information on the rotation angle of the display received from the controller at a first time and information on the rotation angle of the display received from the controller at a second time to identify a rotation angle of the display between the first time and the second time, and control the display to display an image based on the rotation angle of the display.

11. A method of controlling of a display apparatus that includes a display, a motor to rotate the display, and a sensor to detect rotation of the display, the method comprising:
outputting, to the motor, a driving signal to rotate the display,
based on collision of the display with an object being identified based on the driving signal output to the motor and a signal received from the sensor, interrupting output of the driving signal and obtaining information about a rotation angle of the display based on the signal received from the sensor, and
displaying a user interface (UI) associated with the collision based on the information about the rotation angle.

12. The method of claim 11, wherein the obtaining comprises:
based on collision of the display with the object being identified while outputting a driving signal to the motor to rotate the display in a first direction, interrupting output of the driving signal to the motor to rotate the display in the first direction, setting a rotation angle of the display of which rotation is interrupted in accordance with the interruption of output of the driving signal to an initial angle, outputting a driving signal to the motor to rotate the display in a second direction, and while the display rotates in the second direction based on the driving signal output to the motor to rotate the display in the second direction, and obtaining information about the rotation angle of the display based on the initial angle and the driving signal output to the motor to rotate the display in the second direction,
wherein the displaying comprises, while the display rotates in the second direction, displaying a user interface (UI) associated with the collision based on the information about the rotation angle of the display based on the initial angle and the driving signal output to the motor to rotate the display in the second direction.

13. The method of claim 11, wherein:
the driving signal is a pulse signal,
the sensor outputs a pulse signal whenever the display rotates by a predetermined angle, and
the method further comprises identifying the display as colliding with the object based on a relationship between a number of pulse signals output to the motor and a number of pulse signals received from the sensor not satisfying a predetermined relationship, identifying that the display collides with the object.

14. The method of claim 11, further comprising:
based on the display being identified as not colliding with the object while outputting a drive signal to the motor to rotate the display in a first direction, completing rotation of the display based on the number of pulse signals output to the motor, and
based on the display being identified as colliding with the object while outputting the driving signal to the motor to rotate the display in the first direction, outputting a pulse signal to rotate the display in a second direction to the motor, and based on a switch of the display apparatus being turned on by a bar of a gear coupled to the display as the display rotates in the second direction, completing rotation of the display.

15. The method of claim 11, wherein the obtaining comprises, while the display in a first posture rotates in a first direction based on the driving signal output to the motor, obtaining information about a rotation angle of the display based on the initial angle set to the display of the first posture and the driving signal output to the motor, and while the display rotates in the first direction, displaying an image based on the information about the rotation angle of the display.

16. The method of claim 15, wherein the displaying comprises, while the display rotates in the first direction, rotating and displaying the image based on the rotation angle of the display in a second direction which is opposite to the first direction.

17. The method of claim 11, wherein the driving signal output to the motor is to rotate the display in a first direction, and the obtaining comprises, based on collision of the display with an object being identified, setting a rotation of the display of which rotation is interrupted by interruption of output of the driving signal to an initial angle, outputting a driving signal to the motor to rotate the display in a second direction, and while the display rotates in the second direction based on the driving signal output to the motor to rotate the display in the second direction, obtaining information on a rotation angle of the display based on the initial angle set based on the collision with the object and the motor control signal, and the displaying further comprises, while the display is rotating in the second direction, displaying an image based on information on the rotation angle of the display.

18. The method of claim 18, wherein the displaying comprises, while the display is rotating in the second direction, rotating and displaying the image in the first direction based on the rotation angle of the display.

19. The method of claim 18, wherein the displaying comprises overlapping and displaying the UI associated with the collision on the image.

20. The method of claim 11, wherein the displaying further comprises:
receiving, from the controller, information about the rotation angle of the display at a predetermined time interval, applying interpolation to the information on the rotation angle of the display received from the controller at a first time and information on the rotation angle of the display received from the controller at a second time to identify a rotation angle of the display between the first time and the second time, and displaying an image based on the rotation angle of the display.
